(19) United States
(12) Patent Application Publication
(10) Pub. No.: US 2025/0088535 A1
(43) Pub. Date: Mar. 13, 2025

(54) DETECTING PHISHING WEBPAGES VIA TEXTUAL ANALYSIS FROM SCREENSHOTS

(71) Applicant: Fortinet, Inc., Sunnyvale, CA (US)

(72) Inventor: Haitao Li, Coquitlam (CA)

(73) Assignee: Fortinet, Inc., Sunnyvale, CA (US)

(21) Appl. No.: 18/898,306

(22) Filed: Sep. 26, 2024

Related U.S. Application Data
(63) Continuation-in-part of application No. 18/125,916, filed on Mar. 24, 2023.
Application No. 18/125,916 is a continuation-in-part of application No. 16/583,707, filed on Sep. 26, 2019, now abandoned.

(51) Int. Cl. H04L 9/40; G06F 40/279; G06V 30/10

(52) U.S. Cl. CPC H04L 63/1483; G06F 40/279; G06V 30/10

(57) ABSTRACT

To check for phishing, text from a screenshot of the web page and a feature vector describing the text are generated and recognized with OCR. If OCR text is on keyword list, it is determined if web page is suspicious for phishing by inputting features of the web page text in a keyword feature model trained from keyword features of known phishing web pages and/or known legitimate web pages. Responsive to a suspicious web page, web search results are generated from the keywords. Responsive to the suspicious web page not appearing within top web search results, the suspicious web page can be flagged as a phishing web page.

### FIELD OF THE INVENTION

The application claims priority under 35 USC 120 as a continuation-in-part to U.S. patent application Ser. No. 18/125,916, by Haitao Li and Lisheng Ryan Sun, entitled Machine Learning for Visual Similarity-Based Phishing Detection, the contents of which are hereby incorporated by reference in its entirety.

### FIELD OF THE INVENTION

The invention relates generally to computer networks, and more specifically, to web site phishing detection using machine learning of keywords and how the keywords appear.

### BACKGROUND

Phishing attacks are becoming increasingly prominent in the current cybersecurity threat landscape. In recent years, these attacks have grown in sophistication, featuring more targeted phishing artifacts and the use of evasive techniques to avoid detection. This heightened level of sophistication presents a significant challenge for individuals and organizations in detecting new and unknown (zero-day) phishing attacks.

A visual-similarity-based phishing detection method has been proposed to address zero-day phishing attacks. This approach involves comparing the screenshot of a suspected phishing page with that of a legitimate or labeled phishing page. It is effective if hackers use identical templates across different URLs without modifications. However, hackers can evade detection by introducing random content changes within the templates. For instance, they can alter the position or size of the logo or change the background picture, resulting in a screenshot that looks different and bypasses detection based on existing labeled screenshots.

We observe that brand names such as “Amazon” and “PayPal” frequently appear on phishing pages to attract the attention of potential victims. These keywords serve as important indicators for detecting phishing pages, especially when they appear on login pages of domains different from the official. Additionally, these keywords are stable and limited for each target, regardless of how hackers alter the appearance of the phishing page. This stability is a crucial feature for the detection of zero-day phishing attacks.

What is needed is a robust technique for web site phishing detection using machine learning of keywords and how the keywords appear.

### SUMMARY

To meet the above-described needs, methods, computer program products, and systems for web site phishing detection using machine learning of keywords.

In one embodiment, a web page is detected responsive to a web page request. Text from a screenshot of the web page and a feature vector describing the text are generated. An OCR process identifies the text of the snapshot.

In another embodiment, it is determined if the text is on keyword list. If text is on keyword list, it is determined if web page is suspicious for phishing by inputting features of the web page text in a keyword feature model trained from keyword features of known phishing web pages and/or known legitimate web pages.

In yet another embodiment, responsive to a suspicious web page, web search results are generated from the keywords. Responsive to the suspicious web page not appearing within top web search results, the suspicious web page can be flagged as a phishing web page. A security action is taken against the phishing web page.

Advantageously, network performance and computer performance are improved with more stringent security standards.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system for web site phishing detection using machine learning of keywords, according to one embodiment.

FIG. 2 is a more detailed block diagram illustrating a network device of the system of FIG. 1, according to one embodiment.

FIGS. 3A-C are perspective diagrams illustrating web site keywords, according to an embodiment.

FIG. 4 is a high-level flow diagram illustrating a method for web site phishing detection using machine learning of keywords, according to one embodiment.

FIG. 5 is a more detailed flow diagram illustrating a step for textual analysis of web site screenshots, from the method of FIG. 4, according to an embodiment.

FIG. 6 is a block diagram illustrating an example computing device for the system of FIG. 1, according to one embodiment.

### DETAILED DESCRIPTION

Methods, computer program products, and systems for web site phishing detection using machine learning of keywords. One of ordinary skill in the art will recognize many alternative embodiments that are not explicitly listed based on the following disclosure.

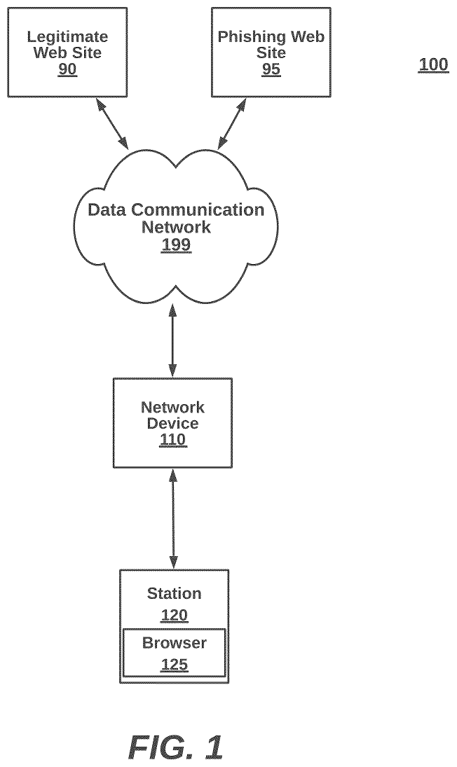

### I. Systems for Machine Learning Phishing Detection (FIGS. 1-3)

FIG. 1 is a high-level block diagram illustrating a system 100 for web site phishing detection using machine learning of keywords, according to one embodiment. The system 100 includes a network device 110 coupled to a data communication network 199 and a station 120. Other embodiments of the system 100 can include additional components that are not shown in FIG. 1, such as controllers, network gateways, firewalls, and access points and stations.

In one embodiment, the components of the automatic system 100 are coupled in communication over a private network connected to a public network, such as the Internet. In another embodiment, system 100 is an isolated, private network. The components can be connected to the data communication system via hard wire (e.g., network device 110). The components can also be connected via wireless networking (e.g., station 120). The data communication network can be composed of any data communication network such as an SDWAN, an SDN (Software Defined Network), WAN, a LAN, WLAN, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802, 11r, 802.11be, Wi-Fi 6, Wi-Fi 6E, Wi-Fi 7 and the like. Components can use IPV4 or IPV6 address spaces.

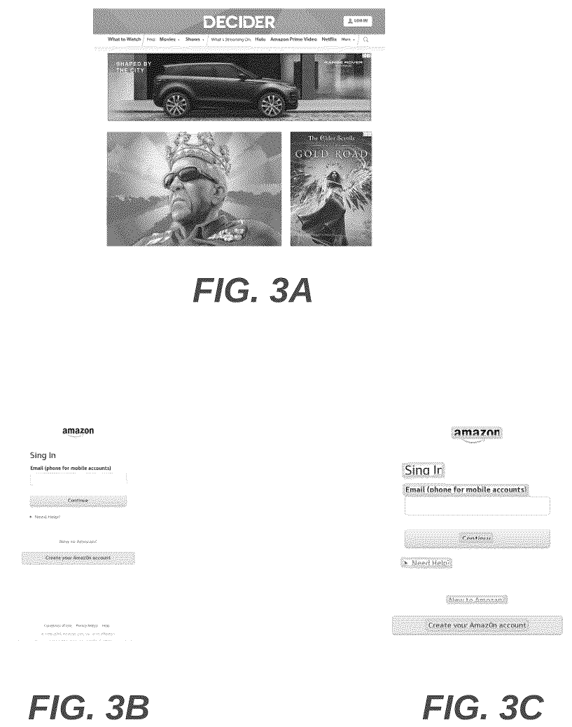

The network device 110 can be a firewall, a network gateway, an access point, a Wi-Fi controller or a station. The network device 110 analyzes text positioning and formatting from screenshots of the web page to identify phishing web pages. For example, legitimate web site 90 uses a sign-on (see FIG. 3B) and phishing web site 95 uses a copycat sign-on (see FIG. 3C) to mislead users seeking legitimate web site 90. A request for a web page can be detected from a browser on a station that passes to an access point before exiting the enterprise network from the network gateway. The snapshot can be captured when the web page is returned from the request. If found to be suspicious, example security actions include a warning displayed to a user, a notification can be sent to a network administrator, or the page can be blocked. A non-phishing web page can be displayed normally on the web browser. The network device 110 can also examine traffic for other malicious activities and to enforce network policies.

For the textual analysis, it is important to note that the mere appearance of these keywords cannot determine if a page is mimicking an official target site, or if the keyword represents the topic of the page. For example, in FIG. 3A, “Amazon” is indeed the topic of the login page. In contrast, in FIG. 3B, “Amazon” is not the topic; the actual topic of the page is “DECIDER.” The network device 110 evaluates whether these keywords can represent the topic of the page. These keywords are usually located at the top part of the page, their font size is typically larger than other text on the page, and they often appear individually in their own block or line. These characteristics will help build a machine-learning model or an artificial intelligence mode. to achieve a high detection accuracy in identifying phishing.

The framework for protecting against zero-day phishing attacks involves the following steps: (1) Screenshot Capture: capture a screenshot of the webpage; (2) OCR Text Extraction: use optical character recognition (OCR) to extract text and position information from the screenshot; (3) Model Based Detection: feed the extracted text and position information into a machine learning model to identify if the web page mimics a phishing target; and (4) Verification by Search Engine: use a search engine to verify if the webpage detected by the model is legitimate, otherwise it is phishing.

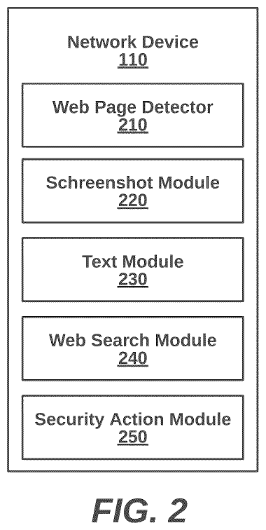

The station 120 further comprises a web browser 125 to display web pages. In some cases, the web pages are displayed within a different web application with web functionality built-in, such as a word processor or a PDF application. The web browser 125 uses HTML received to compose a web page for display to a user. In other embodiments, Extensible Markup Language (XML), JavaScript, Java or other types of web source code can be used to program all or a portion of web pages, and analyzed with the techniques herein. The web browser 125 can be, for example, Google Chrome, Internet Explorer or Edge, Mozilla, or the like, having the components of FIG. 2.

FIG. 2 is a more detailed block diagram illustrating the network device 120 of the system of FIG. 1, according to one embodiment. The network device 110 includes a web page detector 210, a screenshot module 220, a text module 230, a web search module 240, and a security action module 250. The components can be implemented in hardware, software, or a combination of both.

The web page detector 210 can detect a web page responsive to a web page request. Web pages can be identified by text, such a “http” and “com”, by recognizing a request and tracking the response, or by other analysis.

The screenshot module 220 to generate text from a screenshot of the web page and a feature vector describing the text. It can be done by using Chrome headless mode, which lets the browser in an unattended environment without any visible UI. Alternatively, an image file can be captured from a display. A screenshot of 1024*768 pixels resolution is sufficient to achieve high accuracy while minimizing the time to run OCR software on the web page. An example of information associated with a screenshot capture of FIG. 3C includes: {text: Amazon, left: 462, top: 16, width: 100, height: 18,block_num: 1}; {text: Sign In, left: 357, top: 94, width: 81, height: 26,block_num: 2}; {text: Email (phone for mobile accounts), left: 358, top: 139, width: 261, height: 17, block_num: 3}; {text: Continue, left: 472, top: 321, width: 72, height: 13, block_num: 4}; and {text: Need Help?, left: 355, top: 299, width: 99, height: 14, block_num: 5}.

The text module 230 uses an OCR process to identify text of the snapshot and determines if the text is on keyword list. There are many open-source OCR engines to extract text from screenshot picture. For example, Google's Tesseract is one of the most popular OCR Engines. Tesseract is capable of reading the text not only from text on a web page but also off logo that exist on web pages. This is really where the strength of method lies. Most common brands have well-known logos that include text unique to the company. Besides pure text, Tesseract software can also return position information. Specifically, it returns: (1) the block number of text; (2) the top-left coordinate and the width and height of the current Text. They are used to extract feature vectors.

A list of keywords is compiled as targets. A keyword could be a single word like “Amazon” or “Paypal,” or a phrase like “Bank of America” or “Royal Bank of Canada.” Keywords can be obtained by (1) Text Extraction: extract text from these screenshots using an OCR engine; (2) Phrase Counting: count the occurrences of phrases, ranging from 1 to 5 consecutive words, in the text from different screenshots; (3) Sorting and Listing: sort these phrases according to their frequency of occurrence and list the top 10; and (4) Phrase Selection: select one or more phrases as keywords to represent the target. This selection can be done manually or with the assistance of AI tools such as ChatGPT.

If the text is on keyword list, an AI model determines if web page is suspicious for phishing by inputting features of the web page text in a keyword feature model trained from keyword features of known phishing web pages and/or known legitimate web pages. (1) Keyword Itself-keywords themselves are important features. For example, the keyword “Google” is more likely to be a general word within the text rather than a topic word, whereas “Royal Bank of Canada” is more likely to be a topic word. (2) Size of Keyword—the height of the text to represent the keyword font size, and we normalize it based on its rank compared to the sizes of all other words in the text. Usually topic keyword has large font size. (3) Position of Keyword-a topic keyword is more likely to locate at the top of the screenshot. Here, we use the y-coordinate of the keyword to represent its position, indicating its value on the vertical axis in a two-dimensional plane. (4) Occurrence of Keyword—the occurrence of a keyword in the text is important. Generally, the more often a keyword appears, the more likely it is to represent the topic. (5) Word Count in the Same Line as the Keyword-many topic keywords appear alone in a line or with a limited number of accompanying words.

A machine learning model is built to identify if the keyword represents the topic of the page. Many models, such as Logistic Regression (LR), Random Forest, and SVM, can accomplish this. Different models have different requirements for feature format. The features are transformed into a suitable format for the model.

Here, LR, which is a supervised machine learning algorithm widely used for binary classification tasks, such as identifying whether an email is spam or not and diagnosing diseases by assessing the presence or absence of specific conditions based on patient test results. This approach utilizes the logistic (or sigmoid) function to transform a linear combination of input features into a probability value ranging between 0 and 1. This probability indicates the likelihood that a given input corresponds to one of two predefined categories.

TABLE 1
One Hot Encoding

| Apple | Chicken | Broccoli |
|---|---|---|
| 1 | 0 | 0 |
| 0 | 1 | 0 |
| 0 | 0 | 1 |

For the LR model, features 2-5 can be fed directly into the model. However, it does not accept feature 1 (the keyword itself), which is categorical. This feature will be encoded using one-hot encoding, a common method for handling categorical data. Using this technique, a new column is created for each unique value in the original categorical column. These dummy variables are then filled with zeros and ones (1 meaning TRUE, 0 meaning FALSE). An example with three categories is shown in Table 1: “Apple” is encoded as [1, 0, 0], “Chicken” as [0,1,0], and “Broccoli” as [0,0,1].

The web search module 240 to, responsive to a suspicious web page, generates web search results from the keywords. Responsive to the suspicious web page not appearing within top web search results, flagging the suspicious web page as a phishing web page. The final step entails submitting the text processed by the OCR tool to a search engine, like Google, to verify the legitimacy of a website detected by the model. The Google Search API is configured to return only the first 10 results, as this is sufficient for our purposes. Legitimate websites typically appear within the first 10 results due to their high PageRank. In contrast, phishing sites, which are often new and have a low PageRank, do not show up in the top search results. We then compare the top-level domain of the test URL with those of the 10 Google results. If there is no match among the 10 results, the site is identified as phishing; if a match is found, it is confirmed as a legitimate website.

The security module 250 takes a security action against the phishing web page. The security action can be described by rules of a security policy. For instance, the phishing web page can be blocked or quarantined, for example, or notifications can be sent to a user or network administrator.

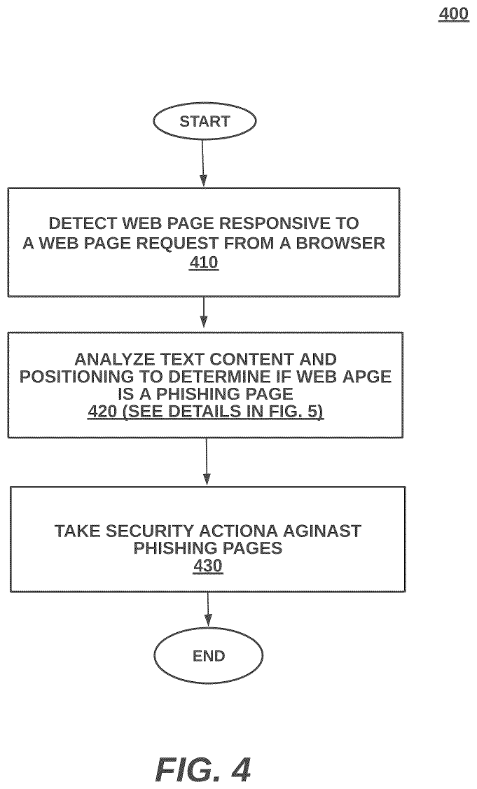

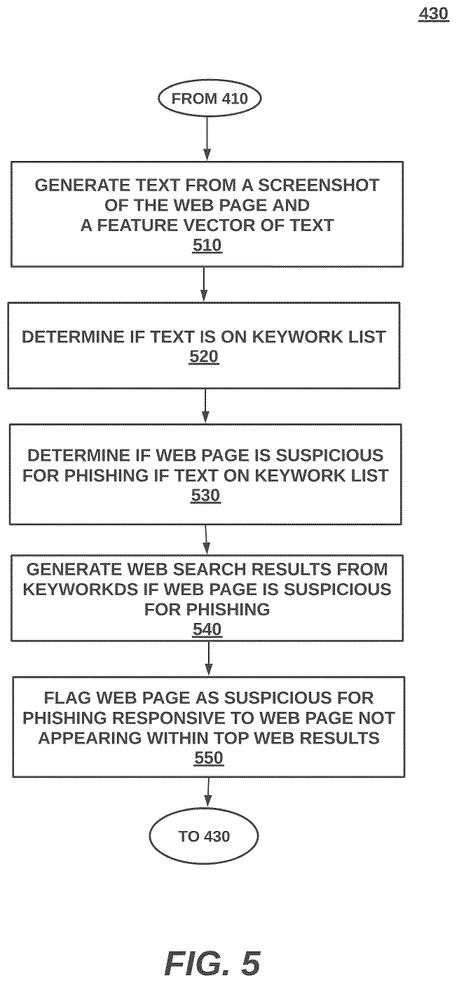

### II. Methods for Machine Leaning Phishing Detection (FIGS. 4-5)

FIG. 4 is a high-level flow diagram illustrating a method 400 for web site phishing detection using machine learning of keywords, according to one embodiment. The method 300 can be implemented by, for example, system 100 of FIG. 1.

At step 410, a web page is detected responsive to a web page request. Text content and positioning is analyzed to determine if the web page is a phishing web page. At step 430, a security action is taken against the phishing web page.

FIG. 5, provides more detail for the web site phishing detection step, according to an embodiment. More specifically, at step 510, text is generated from a screenshot of the web page and a feature vector describing the text, wherein an OCR process identifies the text of the snapshot. It is determined if the text is on keyword list, at step 520.

At step 530, if text is on keyword list, it is determined if web page is suspicious for phishing by inputting features of the web page text in a keyword feature model trained from keyword features of known phishing web pages and/or known legitimate web pages.

At step 540, responsive to a suspicious web page, web search results are generated from the keywords.

At step 550, responsive to the suspicious web page not appearing within top web search results, the suspicious web page is flagged as a phishing web page. The range of top results can be implementation-specific and limited to, for example, top 3, top 10 or top 100 results.

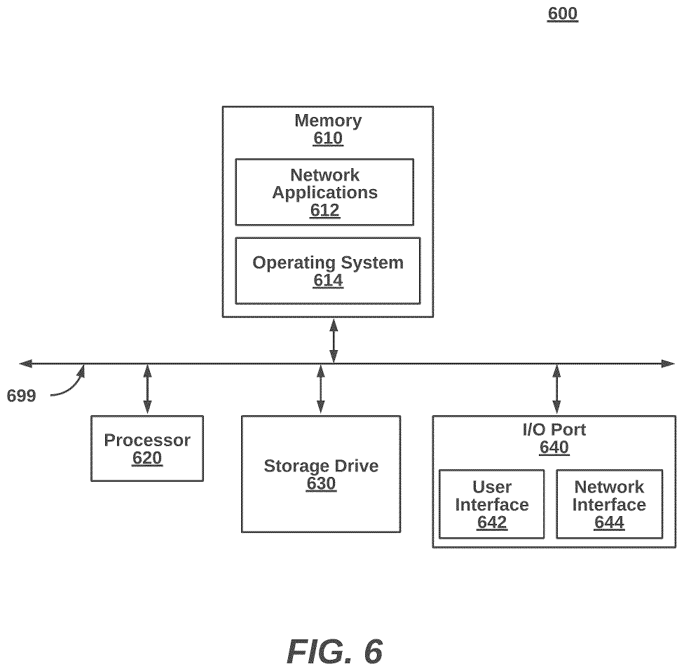

### III. Computing Device for Machine Learning Phishing Detection (FIG. 6)

FIG. 6 is a block diagram illustrating a computing device 600 for use in the system 100 of FIG. 1, according to one embodiment. The computing device 600 is a non-limiting example device for implementing each of the components of the system 100, including the network device 110 and the station 120. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications 612 can include a web browser (e.g., browser 125), a mobile access application, an access application that uses networking, a remote access application executing locally, a network protocol access application, a network management access application, a network routing access applications, or the like.

The operating system 614 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7-11), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, Javascript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11 g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VOIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

I claim:

1. A computer-implemented method in a network device for web site phishing detection using machine learning of keywords, the method comprising:
detecting a web page responsive to a web page request;
generating text from a screenshot of the web page and a feature vector describing the text, wherein an OCR process identifies the text of the snapshot;
determining if the text is on keyword list;
if text is on keyword list, determining if web page is suspicious for phishing by inputting features of the web page text in a keyword feature model trained from keyword features of known phishing web pages and/or known legitimate web pages;
responsive to a suspicious web page, generating web search results from the keywords;
responsive to the suspicious web page not appearing within top web search results, flagging the suspicious web page as a phishing web page; and
taking a security action against the phishing web page.

2. The method of claim 1, wherein the network device comprises one or more of a gateway, an access point, a station, and a browser app.

3. The method of claim 1, wherein the feature vector comprises at least one of keyword list, keyword itself, size, and position.

4. The method of claim 1, the probability estimation is based at least in part on a Hamming distance.

5. A non-transitory computer-readable medium in a network device for web site phishing detection using machine learning of keywords, the method comprising:
detecting a web page responsive to a web page request;
generating text from a screenshot of the web page and a feature vector describing the text, wherein an OCR process identifies the text of the snapshot;
determining if the text is on keyword list;
if text is on keyword list, determining if web page is suspicious for phishing by inputting features of the web page text in a keyword feature model trained from keyword features of known phishing web pages and/or known legitimate web pages;
responsive to a suspicious web page, generating web search results from the keywords;
responsive to the suspicious web page not appearing within top web search results, flagging the suspicious web page as a phishing web page; and
take a security action against the phishing web page.

6. A network device for web site phishing detection using machine learning of keywords, the network device comprising:
a processor;
a network interface communicatively coupled to the processor and to the WLAN; and
a memory, communicatively coupled to the processor and storing:
a web page detector to detect a web page responsive to a web page request;
a screenshot module to generate text from a screenshot of the web page and a feature vector describing the text, wherein an OCR process identifies the text of the snapshot;
a text module to determine if the text is on keyword list, and if the text is on keyword list, determining if web page is suspicious for phishing by inputting features of the web page text in a keyword feature model trained from keyword features of known phishing web pages and/or known legitimate web pages;
a web search module to, responsive to a suspicious web page, generate web search results from the keywords, and responsive to the suspicious web page not appearing within top web search results, flagging the suspicious web page as a phishing web page; and
a security module to take a security action against the phishing web page.
